(19) United States
(12) Patent Application Publication
(10) Pub. No.: US 2025/0113252 A1
(43) Pub. Date: Apr. 3, 2025

(54) SYSTEMS AND METHODS FOR ADAPTIVE, LEARNED CONTROL OF NETWORK AND CONNECTED DEVICES

(71) Applicant: PLUME DESIGN, INC., Palo Alto, CA (US)

(72) Inventors: Badri Srinivasan SAMPATHKUMAR, Fremont, CA (US); Justin KATZ, Houston, TX (US); Stephen H. GRAU, Pleasanton, CA (US); Žane KORELIC, Ljubljana (SI); Zhicheng ZHU, Bellingham, WA (US)

(21) Appl. No.: 18/477,832

(22) Filed: Sep. 29, 2023

(51) Int. Cl. H04W 28/08; H04W 28/02

(52) U.S. Cl. CPC H04W 28/0917; H04W 28/0215

(57) ABSTRACT

Disclosed are systems and methods that provide a computerized location management framework for deterministically managing, controlling and/or configuring. energy and/or network availability, consumption and/or usage by devices at the location. The disclosed framework operates to find and leverage “green hours” at a location based on the network usage of the devices operating at and/or providing the network for the location (e.g., smart phones connected to a Wi-Fi network at the location and/or an access point (AP) device providing the Wi-Fi network, for example). Accordingly, such identified “green hours” can be identified and leveraged to reduce the location's carbon footprint as well as optimize the network for improved network availability and usage via the connected devices.

### FIELD OF THE DISCLOSURE

The present disclosure is generally related to location management, and more particularly, to a decision intelligence (DI)-based computerized framework for deterministically managing, controlling and/or configuring energy and/or network availability, consumption and/or usage by devices at a location.

### BACKGROUND

In today's modern world, many locations, inclusive of homes, offices and the like, have many devices connected to local networks. Such devices can, among other types and forms of impact, cause network and/or power consumption issues to arise, which can impact the integrity of the network, the energy source(s) and/or operation of the location as a whole.

### SUMMARY OF THE DISCLOSURE

Energy issues with network devices at a location can have significant implications for network stability and performance. For example, some common energy related problems can include, but are not limited to, power outages, voltage fluctuations, insufficient power capacity, energy efficiency, environmental considerations, and the like.

For example, sudden power outages can disrupt network operations. Network devices may shut down unexpectedly, leading to downtime and potential data loss if proper backup solutions are not in place. Additionally, variations in voltage, including surges and sags, can damage network equipment over time. This can result in hardware failures and network downtime.

In instances of insufficient power capacities, inadequate power infrastructure can limit the number of devices that can be connected to the network. Overloading circuits or power sources can lead to overheating and equipment failures. Moreover, energy-efficient network devices are important to reduce power consumption and operating costs; however, older or poorly designed equipment may consume more energy than necessary. Indeed, energy consumption by network devices can have environmental impacts, including carbon emissions.

To that end, the disclosed systems and methods provide novel functionality that addresses such energy issues, among others, via a combination of hardware solutions and energy efficient operations that ensure redundancy and resilience in the face of changing network and power demands at a location. As discussed in detail below, the disclosed systems and methods can observe, analyze and determine information and activities for a location, which can include, but are not limited to, usage patterns, interference patterns, people presence patterns, motion correlated with network activity patterns and the like. Such determined and/or derived information can then be leveraged in an on-demand and/or real-time manner to provide energy controls and/or network controls for devices, applications and/or any other type of network-based activities at the location to curate an efficient operational environment that secures resources for optimally predicted times and/or events.

According to some embodiments, a method is disclosed for deterministically managing, controlling and/or configuring energy and/or network availability, consumption and/or usage by devices at a location. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for deterministically managing, controlling and/or configuring energy and/or network availability, consumption and/or usage by devices at a location.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts a non-limiting example recommendation scoring data structure according to some embodiments of the present disclosure;

FIG. 6 depicts an exemplary implementation of an architecture according to some embodiments of the present disclosure;

FIG. 7 depicts an exemplary implementation of an architecture according to some embodiments of the present disclosure; and

FIG. 8 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, the disclosed framework operates to find and leverage “green hours” at a location based on the network usage of the devices operating at and/or providing the network for the location (e.g., smart phones connected to a Wi-Fi network at the location and/or an access point (AP) device providing the Wi-Fi network, for example).

In some embodiments, as discussed below in more detail, network usage can correspond to, but is not limited to, interference in a radio frequency (2.4 GHz, 5 GHZ, 6 GHZ) band, specific application detection and usage pattern (for example, streaming Netflix® every day evening 6-9 p.m.), motion detection and people presence data correlated with network usage at the location, and the like, or some combination thereof. In some embodiments, such network usage data can further or alternatively include, but not be limited to, bandwidth data, throughput data, latency data, packet size, signal strength, transmission frequency, and the like, or some combination thereof.

Accordingly, in some embodiments, such identified “green hours” (e.g., which can be any type of time period, such as, for example, seconds, hours, minutes, days, and the like) can be identified and leveraged to reduce the location's carbon footprint as well as optimize the network for improved network availability and usage via the connected devices.

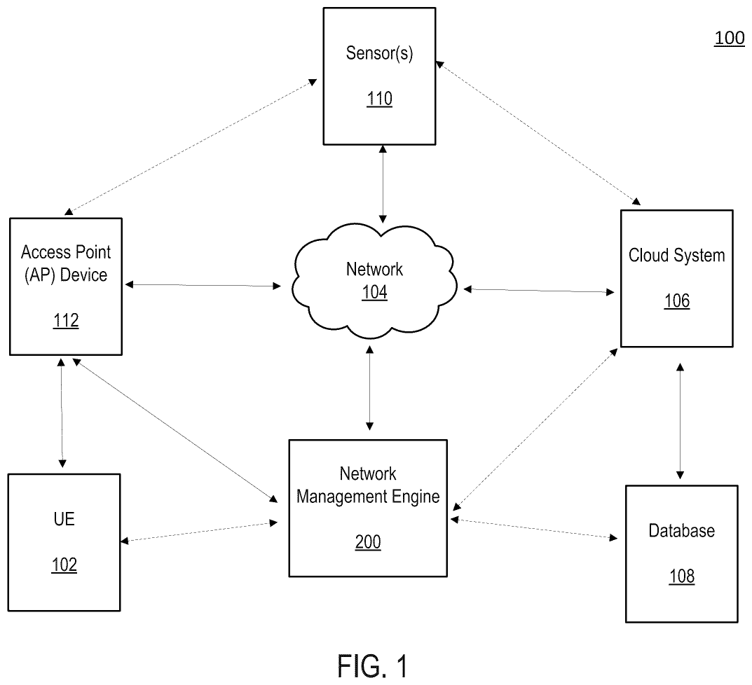

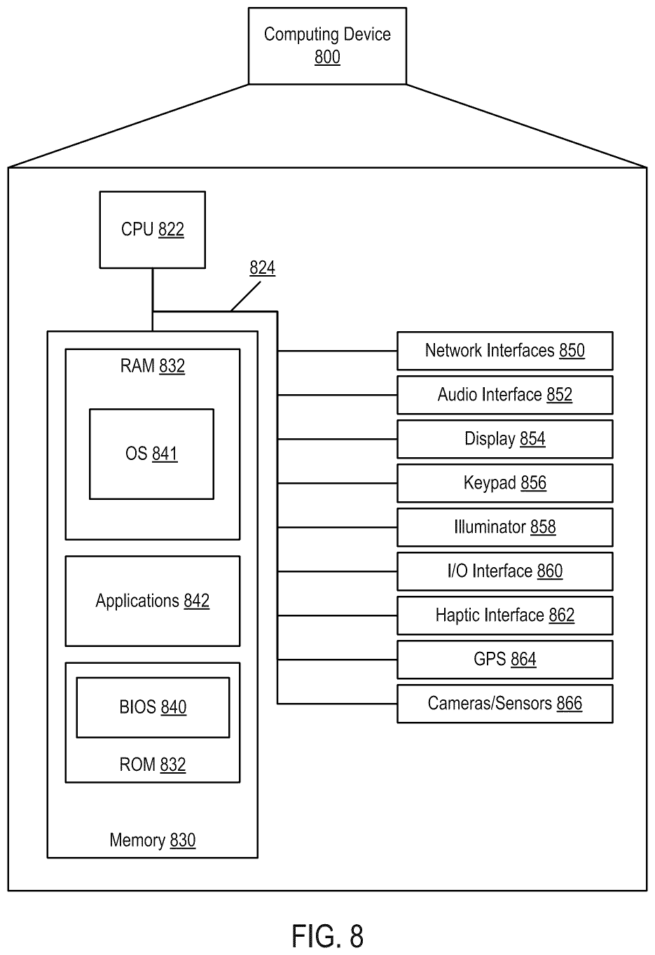

With reference to FIG. 1, system 100 is depicted which includes user equipment (UE) 102 (e.g., a client device, as mentioned above and discussed below in relation to FIG. 8), AP device 112, network 104, cloud system 106, database 108, sensors 110 and network management engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, wearable device, autonomous machine, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

According to some embodiments, sensors 110 can correspond to any type of device, component and/or sensor associated with a location of system 100 (referred to, collectively, as “sensors”). In some embodiments, the sensors 110 can be any type of device that is capable of sensing and capturing data/metadata related to activity of the location. For example, the sensors 110 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device (e.g., a paired smart ring). In some embodiments, sensors 110 can be associated with any device connected and/or operating on cloud system 106 (e.g., a cloud-based device, such as a server that collects information related to the location, for example).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the location management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or network management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

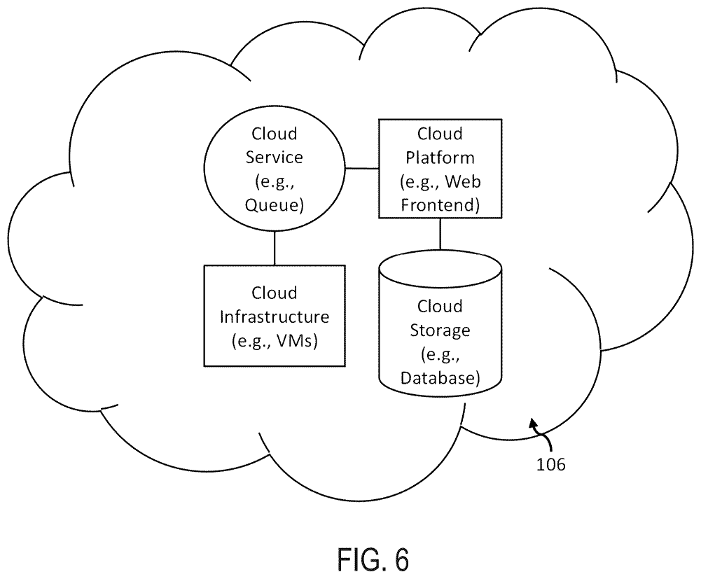

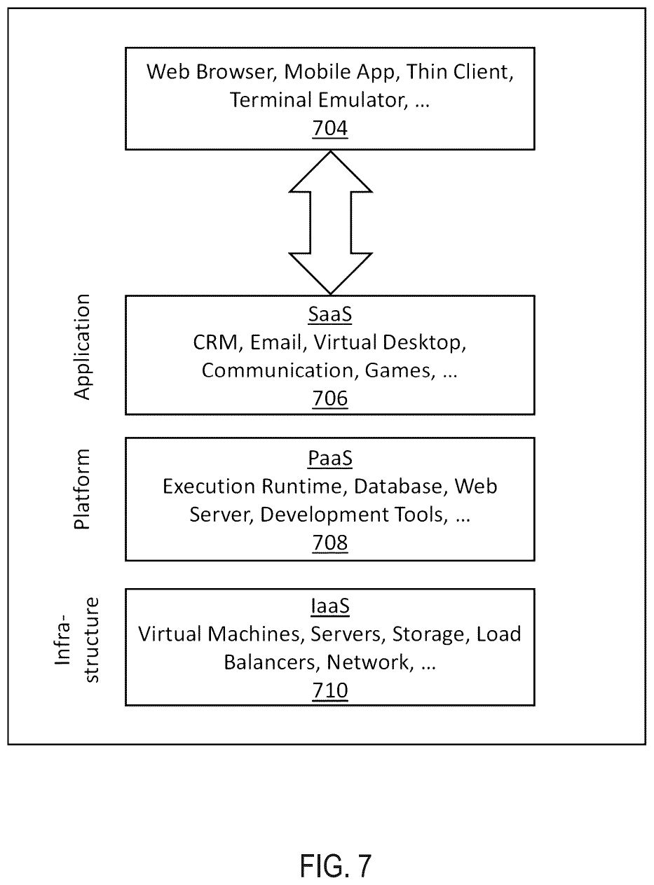

Turning to FIGS. 6 and 7, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 710, platform as a service (PaaS) 708, and/or software as a service (SaaS) 706 using a web browser, mobile app, thin client, terminal emulator or other endpoint 704. FIGS. 6 and 7 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Network management engine 200, as discussed above and further below in more detail, can include components for the disclosed functionality. According to some embodiments, network management engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, network management engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, network management engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112, UE 102 and/or sensors 110. In some embodiments, such application may be a web-based application accessed by AP device 112, UE 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

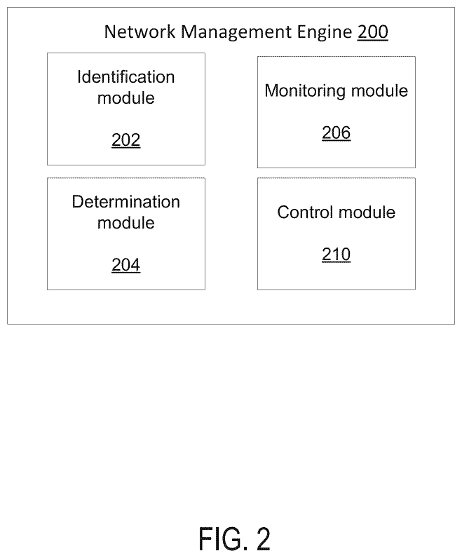

As illustrated in FIG. 2, according to some embodiments, network management engine 200 includes identification module 202, determination module 204, monitoring module 206 and control module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

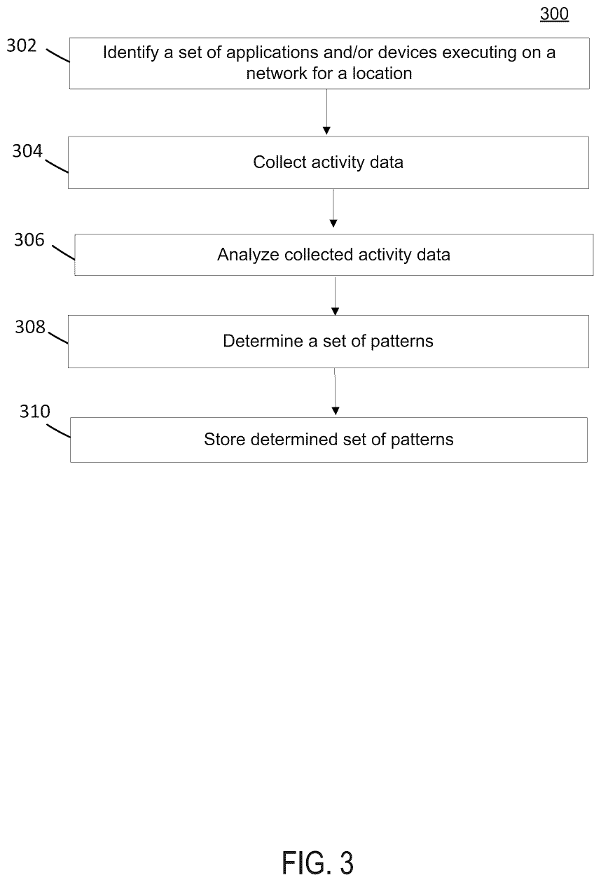

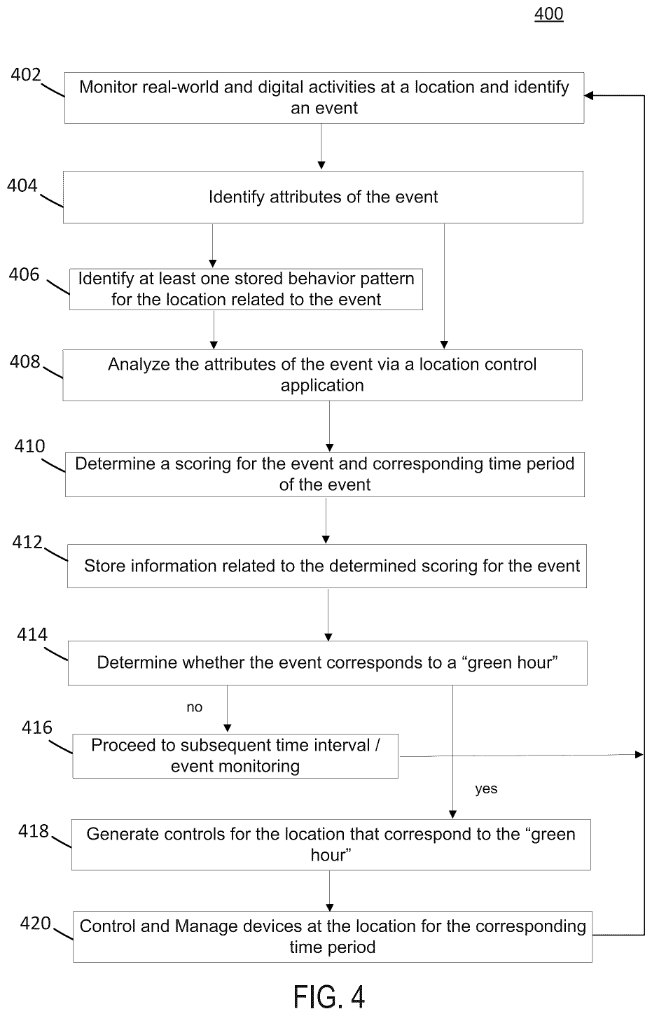

Turning to FIG. 3, Process 300 provides non-limiting example embodiments for the disclosed location management framework. According to some embodiments, Process 300 provides the executable steps for collecting data about the location's network and/or energy operational environment, which as discussed below in relation to Process 400 of FIG. 4, enables the adaptive management of the network and its associated application/device management/control.

According to some embodiments, Steps 302-304 of Process 300 can be performed by identification module 202 of network management engine 200; Steps 306 and 308 can be performed by determination module 204; and Step 310 can be performed by control module 208.

According to some embodiments, Process 300 begins with Step 302 where engine 200 can identify a set of applications and/or devices associated with a location. In some embodiments, the set of devices can be devices that are connected to a network associated with the location, and/or connect to the network at least a threshold amount of times per a threshold amount of time (e.g., connects to the network at least 25 times per month, thereby indicating they live at the location). In some embodiments, the applications can correspond to downloaded, installed and/or web-based applications that execute on such devices and leverage the network at the location to perform application-based processing and/or network resource management implementation.

Any type of application that can execute on a UE can be identified in Step 302 (e.g., Netflix®, YouTube®, Instagram®, Chrome®, Zoom®, and the like). For example, an application can be any type of augmented reality or virtual reality (AR/VR) application, and/or an associated AR/VR device executing such application (e.g., Apple Vision Pro headset, for example).

In some embodiments, such identified devices can include any type of device, which as discussed above, can include UE 102, AP 112 and/or sensor 110, as discussed supra. Thus, as discussed below, the collection of data from/via such devices can correspond to network activity, motion and/or presence activity, and the like, or some combination thereof.

According to some embodiments, a location can correspond to, but is not limited to, a home, office, building, multi-dwelling unit (e.g., apartment complexes, for example) and/or any other type of physical location that can be configured to host and/or provide network connectivity to devices in/around the geographic area. Accordingly, in some embodiments, the network, as discussed above, can be any type of communication network (e.g., a location-based or associated network such as Wi-Fi network, for example) that can enable devices to automatically connect upon being within range of the location and/or access point devices providing the network at/around the location.

Accordingly, in some embodiments, Step 302 can further involve, upon identification of the set of devices, an identification of the applications that are executing on the network from each device. According to some embodiments, identification of an application may be based on a criteria, such that, but not limited to, a certain amount of network traffic may be required to be associated with the application per a threshold time period for the application to be specifically identified. For example, if a user only uses an application once every month, and the application is simply to check stock prices, this minimal data usage may not be adequate to consider as part of the “regular” operations on the network. However, if a user, via their smart TV, streams movies at least 5 days a week, this would be considered a substantial amount of activity, therefore the applications executing on the TV to enable the streaming (e.g., Netflix®, Hulu®, for example) can be identified.

In some embodiments, Step 302 can further involve the identification of information, which can include, but is not limited to, a type of application, identity of application, version of application, subscription level associated with application, account(s) associated with application, device hosting the application, frequency of usage of application, MAC address or IP address of the device, the like, or some combination thereof.

In Step 304, engine 200 can operate to trigger the collection of data (or activity data, used interchangeably) for each device and/or application for a predetermined period of time(s). Accordingly, activity data can correspond to any type of real-world, networked and/or digital data occurring at the location. For example, the collection can be in accordance with intervals (e.g., 8 hour spans of 24 hours so as to establish a usage schedule according to times of the day, for example), and/or can be based on detection of connectivity and usage over the network.

According to some embodiments, such activity data can be collected continuously and/or according to a predetermined period of time or interval. In some embodiments, the data may be collected based on detected events. In some embodiments, type and/or quantity of data may be directly tied to the type of application/device. For example, an application may only generate data for collection upon it being opened on a device and/or engaging in or causing network traffic. In another non-limiting example, a device may generate data for collection upon its initiation and connection to the network (e.g., upon a user getting home from work, their smart phone automatically connects to the Wi-Fi network upon the network becoming within range of the smart phone coming into physical range).

According to some embodiments, the collected data can include information related to, but not limited to, network usage (e.g., downloads, uploads, network resources accessed (e.g., web pages) and the like, which can be specific to a location, UE (user device, access point, for example), application and/or user, or some combination thereof), types of applications, types of devices, user identity, and the like, or some combination thereof. In some embodiments, the activity data can also indicate, but not be limited to, the movements of the users within the location, their frequency of such movements, the identity (ID) of the such users, ID of the devices associated with such users and/or collecting such movements, and the like, or some combination thereof. For example, a motion detection sensor may only collect activity data when movement at or above a velocity by a person weighing above n pounds is detected. In another non-limiting example, a gyroscope sensor on a user's smartphone can detect when a user is moving, the type and/or metrics of such movements.

In some embodiments, the collected data in Step 304 can be stored in database 108 in association with an ID of a user, application, device, location and/or an associated account of any of the preceding user, application, device and/or location.

In Step 306, engine 200 can analyze the collected activity data. According to some embodiments, engine 200 can implement any type of known or to be known computational analysis technique, algorithm, mechanism or technology to analyze the collected data from Step 304.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage a large language model (LLM), whether known or to be known. An LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the collected data, as discussed herein.

According to some embodiments, the AI/ML and/or LLM computational analysis algorithms implemented can be applied and/or executed in a time-based manner, in that collected data for specific time periods can be allocated to such time periods so as to determine patterns of activity (or non-activity) according to a criteria. For example, engine 200 can execute a Bayesian determination for a 24 hour span every 8 hours, so as to segment the day according to applicable patterns, which can be leveraged to determine, derive, extract or otherwise activities/non-activities on the network according to devices/application in/around a location on the location's network.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine a set of patterns for devices (and/or applications) operating on the network at the location. In some embodiments, the patterns can be specific to a user or users, to an application or applications, to a device or devices, and/or some combination thereof. For example, the patterns can indicate that user A typically streams movies on his phone each weeknight from 8 pm to 10 pm in her bedroom; and user B video chats with her friends from 5 pm to 6 pm on the weekend days. In another non-limiting example, a pattern can indicate that the smart speaker in the kitchen typically streams a podcast each weekday morning that is not a holiday. And, in yet another non-limiting example, a pattern can indicate that between the hours of X and Y on Mondays, there is little to no activity (e.g., real-world and/or network activity) at the location (at least below a threshold amount). According to some embodiments, the determined patterns are based on the computational AI/ML and/or LLM analysis performed via engine 200, as discussed above.

Accordingly, in some embodiments, the set of patterns can correspond to, but are not limited to, types of events, types of detected activity, a time of day, a date, type of user, type of application, type of device, duration, amount of activity, quantity of activities, sublocations within the location (e.g., rooms in the house, for example), and the like, or some combination thereof.

In Step 310, engine 200 can store the determined set of patterns in database 108, in a similar manner as discussed above. According to some embodiments, Step 310 can involve creating a data structure associated with each determined pattern, whereby each data structure can be stored in a proper storage location associated with an identifier of the user, application, device and/or location, as discussed above.

In some embodiments, a pattern can comprise a set of events, which can correspond to an activity and/or non-activity (e.g., downloading music content, sending work emails, and the like, for example; or idle times in which network activity and/or traffic is at or below a throughput threshold, for example).

In some embodiments, the pattern's data structure can be configured with header (or metadata) that identifies a user, device, application or the location, and/or a time period/interval of analysis (as discussed above); and the remaining portion of the structure providing the data of the activity/non-activity. In some embodiments, the data structure for a pattern can be relational, in that the events of a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below in relation to Process 400 of FIG. 4. In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the collected data can be identified and analyzed in a raw format, whereby upon a determination of the pattern, the data can be compiled into refined data (e.g., a format capable of being stored in and read from database 108). Thus, in some embodiments, Step 310 can involve the creation and/or modification (e.g., transformation) of the collected data into a storable format.

In some embodiments, as discussed below, each pattern (and corresponding data structure) can be modified based on further detected behavior, as discussed below in relation to Process 400 of FIG. 4.

Turning to FIG. 4, Process 400 provides non-limiting example embodiments for the deployment and/or implementation of the disclosed location management framework for a network at a location.

According to some embodiments, the disclosed framework can learn, generate, compile or otherwise determine patterns of idle times for a location, as discussed supra in relation to FIG. 3, whereby such patterns can be analyzed in view of detected events and/or monitored time periods to determine when particular “green hours” (or idle times) are occurring. Accordingly, device, network and/or energy usage can be throttled so as to realize a reduced carbon footprint for the location, at least for such time periods.

In some embodiments, as discussed below, the disclosed framework can compute recommendations for particular times, dates, events, users, device, locations, and the like. For example, recommendations per day of the week can be compiled and generated using multiple weeks of data on idle hours for a location. In some embodiments, the framework can look back at multiple weeks of daily location idle hours and determine patterns from repeating or overlapping idle hours for each day of the week for each location. In some embodiments, as discussed below, idle hours can be weighted and/or compared per a time period (e.g., day of the week—for example, Mondays will be compared to Mondays in previous weeks; as well as compared to other days of the most recent week, with older data having less weight).

As discussed below, in some embodiments, the disclosed framework can operate to analyze the history of the location's idle hours and determine a scoring for particular time periods (e.g., each hour, each day, each sequential days, weekdays, weekends, and the like, or some combination thereof). For example, if a determined score (e.g., metric or value) for a specific hour is above a recommendation score threshold, then the framework can recommend that specific hour as an idle hour. Thus, as discussed below, in some embodiments, controls can be generated which can enable modifications in the way devices connect to the network, consume energy and the like.

According to some embodiments, Steps 402-406 and 416 can be performed by identification module 202 of network management engine 200; Step 408 can be performed by analysis module 204; Steps 410 and 414 can be performed by determination module 206; Steps 412, 418 and 420 can be performed by output module 208.

According to some embodiments, Process 400 begins with Step 402 where engine 200 can monitor the location to detect, determine or otherwise identify activity related to a user and/or a device. In some embodiments, the monitoring can involve tracking users' movements, actions, presence, interactions (e.g., with other users, sensors, devices and/or items/equipment at the location, for example) and determining activity related to the users at the location. According to some embodiments, for example, engine 200 can detect that a user is using their smart phone to watch streaming media from a content provider. In another example, engine 200 can detect that the user has closed an application on their smart phone, and walked into another room in the location, which is separate from where the smart phone is now located.

In some embodiments, the monitoring and identification of events at the location can correspond to digital activities (e.g., streaming content, for example) and/or real-world activities (e.g., a user entering the location and/or specific room in the location, which can effectuated via any of the sensors discussed above in relation to FIG. 1, discussed supra).

In some embodiments, such monitoring and identification can occur continuously; according to a predetermined threshold, that can be tied to a time period (e.g., every n hour, for example), based on an identity of a device and/or user; based on a type of movement in the location (e.g., sitting versus moving from room to room); based on type of network usage data (e.g., sending emails versus watching streaming media); and the like, or some combination thereof.

Accordingly, in some embodiments, engine 200 can utilize detected and/or stored network traffic and interference thresholds for the time period (e.g., each hour) to collect and analyze the activity data (in a similar manner as per Step 304-306, supra) of a location respective to such thresholds.

Thus, for example, a plurality of events can be detected via Step 402. In some embodiments, for simplicity in explanation, a single event may be discussed below; however, it should not be construed as limiting as any number of events can be detected for the time period being monitored at the location (e.g., activity events for the hour monitoring period, for example).

In Step 404, engine 200 can identify attributes of the activities of the event. As mentioned above, the attributes can corresponds to a plurality of events and/or a time period; therefore, while the discussion herein may focus on analysis of an event, it should not be construed as limiting, as a plurality of events or a time period referencing a set of events can be analyzed for attribute identification and subsequent processing via the steps of Process 400.

For example, motion sensing and people presence data can include attributes related to user ID, timestamps and coordinates within the location (e.g., which room within the location). Accordingly, in some embodiments, engine 200 can analyze the event and the real-world/digital data related thereto, and determine attributes, features and/or characteristics of the event. In some embodiments, such analysis can be performed via the AI/ML and/or LLM analysis discussed above.

In some embodiments, such attributes can correspond to, but not be limited to, ID of a user, ID of a device, type of device, position within the location, type of content, quantity and/or characteristics of content, network usage, energy usage, time period, duration, frequency, and the like, or some combination thereof.

In some embodiments, the attributes can correspond to data/metadata related to, but not be limited to, WiFi interference, network traffic, application detection, people presence detection, motion detection, cloud service data, and the like, or some combination thereof. In some embodiments, engine 200 can collect, gather, retrieve, extract or otherwise identify a total consumed bytes and data from different sources for the location per a predetermined time period (e.g., per hour and/or according to the monitoring performed in Step 402).

In some embodiments, processing steps of Process 400 can proceed from Step 404 to Step 406 then to Step 408; and in some alternative embodiments, Process 400 can proceed from Step 404 to Step 408 (e.g., bypassing Step 406, whereby learned patterns may not be utilized).

Accordingly, in some embodiments, Step 406 can involve engine 200 performing a search of database 108, whereby the search can be based on a query compiled from data associated with the attributes of the event. In some embodiments, such attributes can enable engine 200 to identify stored behavior patterns (from the location) that correspond to known activities at the location, at certain times. For example, if the attributes indicate that a user is in the kitchen at 7 AM on a Monday, then stored behavior patterns related to a user(s) and/or location related to activity at such time and date within the location's kitchen can be retrieved from database 108. Indeed, in some embodiments, a set of previous patterns can be retrieved—for example, patterns from the past n Mondays at 7 AM can be retrieved.

In Step 408, engine 200 can analyze the attributes of the event via a location control application. As discussed above, the location control application can include and/or execute any of the AI, ML and/or LLM applications discussed above, which can enable the analysis as to a determination of a scoring of the event, as discussed infra.

In Step 410, based on the analysis in Step 408, engine 200 can determine a scoring for the event, which can be associated with a time period, which in some embodiments, can be tied to the time period for which the event was identified (e.g., Step 402's monitoring).

According to some embodiments, the score for an event can be computed based on components related to i) a weekday score and ii) an intraweek score. In some embodiments, the weekday score can correspond to activity patterns for each weekday, such as Monday this week vs previous weeks' Mondays. In some embodiments, the intraweek score can correspond to activity patterns within the same week (e.g., the past 7 days, for example).

According to some embodiments, Step 410's scoring determination can involve an evaluation of an event (or time period, as per above) based on both weekday and intraweek scores. In some embodiments, a total score for the event and/or collection of events for the time period can involve a sum of the weekday and intraweek scores. From this total score, a predetermined percentage can be applied, which can realize a recommendation score.

In some embodiments, an additional decay factor (e.g., weighting) can be applied such that older data has less weight on the recommendation decision. For example, a previous week will contribute more to the score compared to the data from five (5) weeks ago.

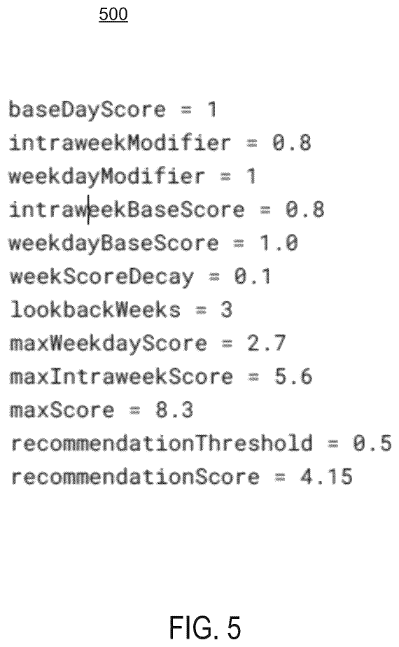

Turning to FIG. 5, depicted is example 500 which provides an example scoring data structure for an event of the time period. In some embodiments, the parameters of the data structure, which can be utilized to provide the recommendation score, are as follows, but are not limiting:
baseDayScore—is the base score for each day. All the other scores are based off of this one. Default: 1;
intraweekModifier—is the modifier that influences intraweekBaseScore (baseDayScore*intraweekModifier), which is the score that each time period (e.g., hour) can receive in the intraweek scoring. In some embodiments, increasing this modifier means the last 7 days (intraweek) can have more impact on total score. Default: 0.8;
weekdayModifier—is the modifier that influences weekdayBaseScore (baseDayScore*weekdayModifier), which is the score that each hour can get in the weekday scoring. In some embodiments, increasing this modifier means that weekday scoring will have more impact on total score. Default: 1;
weekScoreDecay—the decay factor for each week in the past in weekday scoring. In some embodiments, the decay factor can be linear or exponential. For example, if set to 0.1 linear, then each week in the past will contribute 0.1 less score—e.g., week₀—1, week₁—0.9, week₂—0.8, . . . weekₙ. In some embodiments, decreasing this means weekday scoring will have more impact on total score. Default: 0.1 (linear);
lookback Weeks-corresponds to how many weeks' worth of data in the past is engine 200 using for learning patterns (e.g., executing Process 300). In some embodiments, increasing the value of the lookback weeks can also mean more of the total score can be based on weekday scoring. Default: 3;
processingEndDate—the date that engine 200 is utilizing as a basis for Process 400. In some embodiments, an amount of data ingested for learning from location idle hours can be from processingStartDate (=processingEndDate−lookback Weeks) until processingEndDate;
recommendationThreshold—the percentage of total score that a certain time period must reach to be recommended. In some embodiments, increasing this threshold means that each time period (e.g., hour) must historically be idle more often to be recommended. Default: 0.5;

Total score is the maximum score for a certain time period (e.g., hour of a weekday (per location)). In some embodiments, the total score can be based on max WeekdayScore+maxIntraweekScore. For example, if maxIntraweekScore is 7*intraweekBaseScore; max WeekdayScore is based on weekdayBaseScore, taking into account weekScoreDecay and lookback Weeks; and

Recommendation score is total score*recommendationThreshold. According to some embodiments, this is score that each time period must reach to be recommended.

According to some embodiments, in addition to the above parameters, the scoring for an event and/or time period of an event can be cross checked with historical power management state data and discarded, if found that the location was exiting a low power mode state during specific time periods previously (due to interference or traffic reasons, for example). According to some embodiments, the scoring for an event and/or time period of an event can be cross checked with real behavior of the network and its devices at the location compared to the predictions (from Step 310, discussed supra). Accordingly, in some embodiments, if the behavior is determined to comply with the stored prediction (or pattern) (e.g., at or below a similarity threshold value), a positive reinforcement score can be provided; and in some embodiments, if the behavior is determined to deviate (above the similarity threshold value), then engine 200 can generate a negative reinforcement score. Accordingly, a positive and/or negative reinforcement score can be at or proximate a value or metric that causes the engine to act in accordance with the functionality discussed herein, and in more detail below. In some embodiments, this can enable engine 200 to tune the location control application against incorrect assumptions of idle hours.

Turning back to Process 400, in Step 412, engine 200 can store the information related to the determined scoring for the event. In some embodiments, the storing in Step 412 can include, but not be limited to, the attributes of the event, time period, scoring parameters, retrieved pattern(s), and the like, or some combination thereof. In some embodiments, such storing can involve updating of the patterns retrieved in Step 406 and/or creating new patterns. In some embodiments, upon completion of Steps 416 or Step 420, the storage operations of Step 412 can be repeated in a similar manner.

In Step 414, engine 200 can determine whether the event corresponds to a “green hour”. As discussed above, such determination can be based on the recommendation determined as part of the scoring from Step 410 and example 500 from FIG. 5.

In some embodiments, in Step 416, when the scoring recommendation is below the recommendation threshold, processing can proceed to Step 402, where further monitoring for a subsequent time period can proceed without any modifications to the network usage, device usage and/or energy usage at the location.

In some embodiments, in Step 418, when the determination in Step 414 includes the identification that the scoring of the event meets and/or exceeds the recommendation threshold, engine 200 can generate (digital and/or electronic) controls and/or configuration files that correspond to the execution of the “green hour”. According to some embodiments, such controls can correspond to a device's operability, which can include, but is not limited to, turning a device on or off, changing the operational mode of a device, and the like. For example, a heating, ventilation and air conditioning (HVAC), refrigerator, water heater, water purifier, automobile, oven, and the like, can be configured to be turned on/off, operate in a specific mode and/or be timed to operate based on other device operations based on the controls determined in Step 418 and implemented in Step 420.

According to some embodiments, recommended time slots can be combined to a “FROM-TO” idle schedule for the location (e.g., where FROM corresponds to a start time and TO corresponds to an end time). In some embodiments, the schedule can be for a specific time period (e.g., day, for example). Such schedule can include executable controls and/or configuration files which can include instructions for controllers of devices to operate. For example, such controls can cause devices to enter “low power mode” for the recommended time period of the “green hour”.

And, in Step 420, such controls can be executed, which can cause the modification, management and/or altered operations of the devices and/or network at the location. Thus, in some embodiments, the location can have, but not be limited to, devices enter low power modes, devices turn off, have the network throttled, have certain devices have certain antennas off, turn off certain AP devices, prevent particular applications from opening and/or executing, and the like, or some combination thereof. Thus, for example, such controls can enable the preservation (or conservation) of energy during the recommended (idle) time period. In another example, the network capacity and/or availability can be reduced (e.g., throttle bandwidth a determined value) so as to evidence a reduction in energy consumption of such devices.

In some embodiments, such controls can be effectuated or “put in place” for the recommended time period, whereby upon completion of the “FROM-TO” time period, the location's network and/or energy usage can resume previous activity or the next determined activity (as per the recursive nature of the algorithm represented by Process 400).

Thus, in some embodiments, as depicted in FIG. 4, Process 400 can recursively proceed from Step 420 (or Step 416, as discussed above) to Step 402, where the network traffic and/or characteristics of the users and/or devices operating at a location can be monitored so as to ensure the proper network/energy configuration is currently being activated and implemented for the location and/or the applications operating therein.

According to some embodiments, a location can have a dedicated engine 200 model so that the location management protocols applied to the network/energy (e.g., power source) at the location can be specific to the events and patterns learned and detected on that network. In some embodiments, the model can be specific for an application, set of applications, a device, set of devices and/or user or set of users (e.g., users that live at a certain location (e.g., a house), and/or are within a proximity to each other (e.g., work on the same floor of an office building, for example)).

FIG. 8 is a schematic diagram illustrating a client device showing an example embodiment of a client device that may be used within the present disclosure. Client device 800 may include many more or less components than those shown in FIG. 8. However, the components shown are sufficient to disclose an illustrative embodiment for implementing the present disclosure. Client device 800 may represent, for example, UE 102 discussed above at least in relation to FIG. 1.

As shown in the figure, in some embodiments, Client device 800 includes a processing unit (CPU) 822 in communication with a mass memory 830 via a bus 824. Client device 800 also includes a power supply 826, one or more network interfaces 850, an audio interface 852, a display 854, a keypad 856, an illuminator 858, an input/output interface 860, a haptic interface 862, an optional global positioning systems (GPS) receiver 864 and a camera(s) or other optical, thermal or electromagnetic sensors 866. Device 800 can include one camera/sensor 866, or a plurality of cameras/sensors 866, as understood by those of skill in the art. Power supply 826 provides power to Client device 800.

Client device 800 may optionally communicate with a base station (not shown), or directly with another computing device. In some embodiments, network interface 850 is sometimes known as a transceiver, transceiving device, or network interface card (NIC).

Audio interface 852 is arranged to produce and receive audio signals such as the sound of a human voice in some embodiments. Display 854 may be a liquid crystal display (LCD), gas plasma, light emitting diode (LED), or any other type of display used with a computing device. Display 854 may also include a touch sensitive screen arranged to receive input from an object such as a stylus or a digit from a human hand.

Keypad 856 may include any input device arranged to receive input from a user. Illuminator 858 may provide a status indication and/or provide light.

Client device 800 also includes input/output interface 860 for communicating with external. Input/output interface 860 can utilize one or more communication technologies, such as USB, infrared, Bluetooth™, or the like in some embodiments. Haptic interface 862 is arranged to provide tactile feedback to a user of the client device.

Optional GPS transceiver 864 can determine the physical coordinates of Client device 800 on the surface of the Earth, which typically outputs a location as latitude and longitude values. GPS transceiver 864 can also employ other geo-positioning mechanisms, including, but not limited to, triangulation, assisted GPS (AGPS), E-OTD, CI, SAI, ETA, BSS or the like, to further determine the physical location of client device 800 on the surface of the Earth. In one embodiment, however, Client device 800 may through other components, provide other information that may be employed to determine a physical location of the device, including for example, a MAC address, Internet Protocol (IP) address, or the like.

Mass memory 830 includes a RAM 832, a ROM 834, and other storage means. Mass memory 830 illustrates another example of computer storage media for storage of information such as computer readable instructions, data structures, program modules or other data. Mass memory 830 stores a basic input/output system (“BIOS”) 840 for controlling low-level operation of Client device 800. The mass memory also stores an operating system 841 for controlling the operation of Client device 800.

Memory 830 further includes one or more data stores, which can be utilized by Client device 800 to store, among other things, applications 842 and/or other information or data. For example, data stores may be employed to store information that describes various capabilities of Client device 800. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 800.

Applications 842 may include computer executable instructions which, when executed by Client device 800, transmit, receive, and/or otherwise process audio, video, images, and enable telecommunication with a server and/or another user of another client device. Applications 842 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
detecting, over a network at a location, an event corresponding to a time period, the event comprising data related to real-world and/or digital activities at the location;
identifying, from a database, at least one pattern of activity for the location, the at least one pattern of activity comprising information indicating real-world and/or digital activities from a previous time period;
analyzing the event based at least in part on the at least one pattern of activity;
determining, based on the analysis, a type of activity for the event and time period; and
executing, based on the determination, electronic controls of devices associated with the network.

Aspect 2. The method of aspect 1, wherein the electronic controls correspond to at least one of energy availability, network availability and capacity, and device operability.

Aspect 3. The method of aspect 1, wherein the type of activity for the event corresponds to idle activity, wherein the electronic controls correspond to a conservation of energy for the devices.

Aspect 4. The method of aspect 1, wherein the type of activity for the event corresponds to activity at or above a threshold level, wherein the devices are monitored for a subsequent time period.

Aspect 5. The method of aspect 1, further comprising:
analyzing the event and determining, based on the event analysis, attributes for the event;
determining, based on the attributes of the event and the information of the at least one pattern of activity, a set of scoring parameters; and
computing a recommendation score based on the set of scoring parameters, wherein the determination of the type of activity is based on the recommendation score.

Aspect 6. The method of aspect 5, wherein the recommendation score is based on at least two components that correspond to a differing set of time periods for activities at the location.

Aspect 7. The method of aspect 5, wherein the attributes comprise information related to at least one of network data, network usage data, application data, usage patterns, motion detection, presence data.

Aspect 8. The method of aspect 1, further comprising:
collecting activity data from a plurality of devices operating on the network;
analyzing the activity data;
determining a plurality of patterns of behavior for the network; and
storing the determined plurality of patterns of behavior, wherein the at least one pattern of activity is a stored pattern of behavior.

Aspect 9. The method of aspect 1, further comprising:
identifying a set of activity patterns, wherein the set of activity patterns correspond to previous activities occurring at previous time periods that are similar to the time period, wherein the analysis of the event is based on the set of activity patterns.

Aspect 10. The method of aspect 1, wherein the event comprises a set of events for the time period.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
detecting, over a network at a location, an event corresponding to a time period, the event comprising data related to real-world and/or digital activities at the location;
identifying, from a database, at least one pattern of activity for the location, the at least one pattern of activity comprising information indicating real-world and/or digital activities from a previous time period;
analyzing the event based at least in part on the at least one pattern of activity;
determining, based on the analysis, a type of activity for the event and time period; and
executing, based on the determination, electronic controls of devices associated with the network.

2. The method of claim 1, wherein the electronic controls correspond to at least one of energy availability, network availability and capacity, and device operability.

3. The method of claim 1, wherein the type of activity for the event corresponds to idle activity, wherein the electronic controls correspond to a conservation of energy for the devices.

4. The method of claim 1, wherein the type of activity for the event corresponds to activity at or above a threshold level, wherein the devices are monitored for a subsequent time period.

5. The method of claim 1, further comprising:
analyzing the event and determining, based on the event analysis, attributes for the event;
determining, based on the attributes of the event and the information of the at least one pattern of activity, a set of scoring parameters; and
computing a recommendation score based on the set of scoring parameters, wherein the determination of the type of activity is based on the recommendation score.

6. The method of claim 5, wherein the recommendation score is based on at least two components that correspond to a differing set of time periods for activities at the location.

7. The method of claim 5, wherein the attributes comprise information related to at least one of network data, network usage data, application data, usage patterns, motion detection, presence data.

8. The method of claim 1, further comprising:
collecting activity data from a plurality of devices operating on the network;
analyzing the activity data;
determining a plurality of patterns of behavior for the network; and
storing the determined plurality of patterns of behavior, wherein the at least one pattern of activity is a stored pattern of behavior.

9. The method of claim 1, further comprising:
identifying a set of activity patterns, wherein the set of activity patterns correspond to previous activities occurring at previous time periods that are similar to the time period, wherein the analysis of the event is based on the set of activity patterns.

10. The method of claim 1, wherein the event comprises a set of events for the time period.

11. A device comprising:
a processor configured to:
detect, over a network at a location, an event corresponding to a time period, the event comprising data related to real-world and/or digital activities at the location;
identify, from a database, at least one pattern of activity for the location, the at least one pattern of activity comprising information indicating real-world and/or digital activities from a previous time period;
analyzing the event based at least in part on the at least one pattern of activity;
determining, based on the analysis, a type of activity for the event and time period; and
executing, based on the determination, electronic controls of devices associated with the network.

12. The device of claim 11, wherein the type of activity for the event corresponds to idle activity, wherein the electronic controls correspond to a conservation of energy for the devices.

13. The device of claim 11, wherein the processor is further configured to:
analyze the event and determining, based on the event analysis, attributes for the event;
determine, based on the attributes of the event and the information of the at least one pattern of activity, a set of scoring parameters; and
compute a recommendation score based on the set of scoring parameters, wherein the determination of the type of activity is based on the recommendation score.

14. The device of claim 13, wherein the recommendation score is based on at least two components that correspond to a differing set of time periods for activities at the location, wherein the attributes comprise information related to at least one of network data, network usage data, application data, usage patterns, motion detection, presence data.

15. The device of claim 11, wherein the processor is further configured to:
identify a set of activity patterns, wherein the set of activity patterns correspond to previous activities occurring at previous time periods that are similar to the time period, wherein the analysis of the event is based on the set of activity patterns.

16. A non-transitory computer-readable storage medium tangibly encoded with computer-executable instructions that when executed by a device, perform a method comprising:
detecting, over a network at a location, an event corresponding to a time period, the event comprising data related to real-world and/or digital activities at the location;
identifying, from a database, at least one pattern of activity for the location, the at least one pattern of activity comprising information indicating real-world and/or digital activities from a previous time period;
analyzing the event based at least in part on the at least one pattern of activity;
determining, based on the analysis, a type of activity for the event and time period; and
executing, based on the determination, electronic controls of devices associated with the network.

17. The non-transitory computer-readable storage medium of claim 16, wherein the type of activity for the event corresponds to idle activity, wherein the electronic controls correspond to a conservation of energy for the devices.

18. The non-transitory computer-readable storage medium of claim 16, further comprising:
analyzing the event and determining, based on the event analysis, attributes for the event;
determining, based on the attributes of the event and the information of the at least one pattern of activity, a set of scoring parameters; and
computing a recommendation score based on the set of scoring parameters, wherein the determination of the type of activity is based on the recommendation score.

19. The non-transitory computer-readable storage medium of claim 18, wherein the recommendation score is based on at least two components that correspond to a differing set of time periods for activities at the location, wherein the attributes comprise information related to at least one of network data, network usage data, application data, usage patterns, motion detection, presence data.

20. The non-transitory computer-readable storage medium of claim 16, further comprising:
identifying a set of activity patterns, wherein the set of activity patterns correspond to previous activities occurring at previous time periods that are similar to the time period, wherein the analysis of the event is based on the set of activity patterns.
